(19) United States
(12) Patent Application Publication
(10) Pub. No.: US 2019/0232700 A1
(43) Pub. Date: Aug. 1, 2019

(54) METHOD AND COATING COMPOSITION FOR PRINT MEDIA

(71) Applicant: MEMJET TECHNOLOGY LIMITED, Dublin (IE)

(72) Inventors: Zeying Ma, San Diego, CA (US); Ellaine Munton, North Ryde (AU); Monica Romelczyk, San Diego, CA (US)

(21) Appl. No.: 16/256,981

(22) Filed: Jan. 24, 2019

Related U.S. Application Data
(60) Provisional application No. 62/624,028, filed on Jan. 30, 2018.

(51) Int. Cl. B41M 5/00; C09D 11/322; C09D 129/04; C08K 3/32; C08K 3/22; C08K 3/36

(52) U.S. Cl. CPC B41M 5/0017; C09D 11/322; C09D 129/04; C08K 3/32; B41F 5/24; C08K 3/36; C08K 2003/329; C08K 2003/2227; C08K 3/22

(57) ABSTRACT

A method of applying a coating composition to print media includes the steps of: coating a metal roller with the coating composition; and transferring the coating composition to the print media to provide a coated print media. The coating composition is an acidic aqueous-based composition containing: (i) a water-absorbing component selected from the group consisting of: hydrophilic polymers and hydrophilic metal oxides; and (ii) phosphoric acid.

### CROSS-REFERENCE TO RELATED APPLICATIONS

The present application claims the benefit of priority under 35 U.S.C. § 119(e) of U.S. Provisional Application No. 62/624,028, entitled METHOD AND COATING COMPOSITION FOR PRINT MEDIA, filed on Jan. 30, 2018, the contents of which is hereby incorporated by reference in its entirety for all purposes.

### FIELD OF THE INVENTION

This invention relates to a coating method and a coating composition for print media. It has been developed primarily for coating offset print media using a flexo process, such that the coated media is suitable for use in a digital inkjet press.

### BACKGROUND OF THE INVENTION

The Applicant has developed a range of Memjet® inkjet printers suitable for use as commercial digital inkjet presses. For example, a high-speed print engine having a plurality of monochrome inkjet printheads is described U.S. Pat. No. 8,616,678, the contents of which are incorporated herein by reference. A high-speed digital press having a scalable array of print modules and maintenance modules is described in US 2017/0313080, the contents of which are incorporated herein by reference.

Digital inkjet presses are growing in popularity and are replacing traditional analog presses in many scenarios, especially for relatively short print runs. However, conventional offset media are typically not well suited for receiving aqueous inkjet inks. In particular, glossy and semi-glossy offset papers, such as those used in magazines and the like, resist absorption of water resulting in slow dry times and problems such as “intercolor bleed”, whereby different colors of ink bleed into one another and “coalescence”, whereby ink droplets spread laterally across the media surface and coalesce with adjacent droplets.

Such problems are well-known in the art and several different approaches have been used to modify offset media for use in digital inkjet presses. Modifying conventional offset media, either via an inline or offline coating process, is generally a more economical approach than developing special print media suitable for receiving aqueous inkjet inks. Moreover, use of non-glossy media in commercial digital presses is usually not viable, since penetration of inkjet pigments into the porous media results in a loss of optical density and mottling.

One approach for coating conventional offset media is to use a coating composition comprising a multivalent metal salt and/or a cationic polymer. The cationic charges in the coating composition trigger aggregation of pigment particles and help to control intercolor bleed. Other types of coating compositions use components which rapidly absorb water and assist with drying of aqueous inkjet inks so as to improve print quality. For example, coating compositions comprising hydrophilic polymers (e.g. polyvinyl alcohol (PVOH)) or hydrophilic metal oxides (e.g. fumed silica or fumed alumina) have been described in the art. In some cases, a latex and/or polyurethane binders are included in the coating composition for improving the integrity of the coating film and improving adhesion of the coating film to print media.

Coating compositions may be applied to print media either via an inkjet printing process or via a dedicated upstream applicator (e.g. roller applicator). Jetting of the coating composition advantageously obviates a dedicated applicator in the media path. However, j enable fluids are required to have a relatively low viscosity; therefore, PVOH and/or silica coatings are not available for coating via inkjet printing.

An attractive method for application of coatings is using a “flexo” printing process (flexography). In the flexo process, ink is transferred to an anilox roller, which provides a measured amount of ink for a flexo printing plate ensuring an even coverage of the ink during printing. The anilox roller is typically a steel or aluminum roller having thousands of microscopically engraved cells, each of which carries a predetermined volume of ink. Flexo printing is very familiar to commercial press operators and, in principle, adaptable to printing of media coating compositions (“primer fluids”).

However, anilox rollers are conventionally used with non-corrosive offset inks, whereas coating compositions for digital inkjet printing are generally acidic. A low pH assists with aggregation of pigment particles, which typically have a negative zeta potential. However, the anilox roller is susceptible to acid corrosion, which is exacerbated by corrosive metal salts typically found in coating compositions. Corrosion of the anilox roller causes pitting of the engraved cells, resulting in an undesirable uneven coating of the primer fluid and a subsequent loss of print quality.

It would therefore be desirable to provide a method of applying an acidic coating composition to print media using flexography, such that the print media is suitable for receiving aqueous inkjet inks.

### SUMMARY OF THE INVENTION

In a first aspect, there is provided a method of applying a coating composition to print media comprising the steps of:

coating a metal roller with the coating composition; and

transferring the coating composition to the print media, wherein the coating composition is an acidic aqueous-based composition comprising:
(i) a water-absorbing component selected from the group consisting of: hydrophilic polymers and hydrophilic metal oxides; and
(ii) phosphoric acid.

In one embodiment, the coating composition further comprises a pigment-aggregating component. For example, the coating composition may comprise a comprises a pigment-aggregating component selected from the group consisting of multivalent metal salts (e.g. calcium salt) and cationic polymers.

Typically, the hydrophilic polymer is a polyvinyl alcohol. Preferably, the polyvinyl alcohol has a molecular weight in the range of 30,000 to 500,000 g/mol, or preferably 50,000 to 300,000 g/mol.

Typically, the hydrophilic metal oxide is selected from the group consisting of: fumed silica and fumed alumina.

Preferably, the coating composition has a pH in the range of 2 to 4, or preferably 3 to 4.

Preferably, the method uses flexography to apply the coating composition to the print media. Preferably, the metal roller is an anilox roller and the coating composition is transferred via at least one other roller. Preferably, the metal roller is comprised of stainless steel.

Preferably, an amount of the hydrophilic polymer is in the range of 0.1 to 10 wt. %, preferably 1 to 10 wt. %, or preferably 1 to 8 wt. %. Preferably, boric acid is also present in a range of 0.01 to 1 wt. %, or preferably 0.05 to 0.5 wt. %.

Preferably, an amount of phosphoric acid is in the range of 0.05 to 10 wt. %, or preferably, 0.1 to 10 wt. %, or preferably, 1 to 7 wt. %.

In some embodiments, the method further comprises the subsequent step of printing onto the print media using a downstream inline inkjet printing assembly. Typically, the inkjet printing assembly prints onto the print media using one or more aqueous pigment-based inks.

In a second aspect, there is provided an acidic aqueous-based composition comprising:
(i) a water-absorbing component selected from the group consisting of: hydrophilic polymers and hydrophilic metal oxides; and
(ii) phosphoric acid.

### BRIEF DESCRIPTION OF THE DRAWINGS

Various embodiments of the present invention will now be described by way of example only with reference to the accompanying drawing, in which:—

FIG. 1 is a schematic view of a flexo printing assembly suitable for use in the method according to the first aspect.

### DETAILED DESCRIPTION OF THE INVENTION

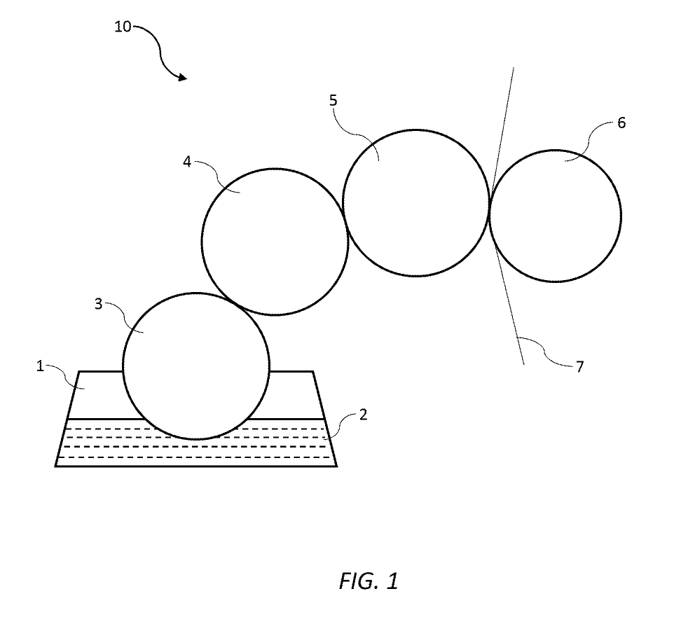

Referring to FIG. 1, there is shown a flexo printing assembly 10 having a fluid pan 1 containing coating composition 2. The coating composition 2 is an acidic aqueous-based coating composition of the type described herein. A transfer roller 3 dipped in the fluid pan 1 transfers the coating composition 2 from the fluid pan to an anilox roller 4. The anilox roller 4 meters the fluid to a uniform thickness onto a plate cylinder 5. A web of print media 7 (e.g. a conventional offset media web) then moves between the plate cylinder 5 and an impression cylinder 6 with the impression cylinder applying pressure to the plate cylinder, thereby transferring the coating composition 2 onto the web. The coated media may then be fed to a downstream drying unit (not shown).

After drying, the coated media may either be wound onto a roll for subsequent use in a digital printing press. Alternatively, the coated media may be fed from the flexo printing assembly 10 to an inline downstream digital printing assembly (not shown), such as the digital printing assembly described in US 2017/0313080, the contents of which are incorporated herein by reference.

As foreshadowed above, the coating composition 2 is an aqueous-based acidic composition comprising (i) a water-absorbing component selected from the group consisting of: hydrophilic polymers and hydrophilic metal oxides; and (ii) phosphoric acid. The coating composition is necessarily acidic in order to aggregate (“crash out”) pigments in inkjet inks subsequently printed onto the media. Typically, the coating composition has a pH of 3 to 4, which is sufficient to aggregate dispersed pigment particles having a negative zeta potential (e.g. inkjet pigments having surface carboxylate groups).

Without wishing to be bound by theory, it is understood by the present inventors that the phosphoric acid in the coating composition forms an insoluble iron phosphate passivating layer on the anilox roller 4 and thereby minimizes corrosion. Unlike other irons salts, such as chloride, acetate and sulfate salts, the phosphate salt advantageously protects the anilox roller 4 from corrosive attack by the acidic coating composition 2, such that flexo printing of the coating composition becomes viable without modifying the flexo printing assembly 10.

In some embodiments, the coating composition may include a multivalent metal salt. Examples of suitable multivalent metal cations include Mg²⁺, Ca²⁺, Ba²⁺, Zn²⁺, and Al³⁺, preferably Ca²⁺ and/or Mg²⁺ in combination with suitable counter ions. Specific examples of suitable metal salts include (but are not limited to) calcium chloride, calcium acetate, calcium nitrate, magnesium chloride, magnesium acetate, magnesium nitrate, barium chloride, barium nitrate, zinc chloride, zinc nitrate, aluminum chloride, aluminum hydroxychloride, and aluminum nitrate. Combinations of the salts described above may also be used.

In some embodiments, the coating composition may include a cationic polymer, such as a quaternary amine, a polyamine (e.g. polyethyleneimine (“PEI”)), a polyguanidine cationic polymer and combinations thereof.

In some embodiments, the coating composition may include a binder, such as styrene-acrylic polymers and polyurethanes. Specific examples of suitable styrene-acrylic polymers include Joncryl® resins available from BASF Corporation.

The coating composition typically contains one or more co-solvents to assist with solubilizing organic components. For example, the coating composition may contain one or more co-solvents selected from alcohols, diols, glycols etc, as well alkoxylated derivatives thereof. Examples of water-soluble co-solvents typically found in aqueous ink vehicles will be well known to the person skilled in the art.

The coating composition may contain one or more surfactants. Examples of suitable surfactants typically found in aqueous ink vehicles will be well known to the person skilled in the art.

### EXAMPLES

A coating composition was formulated according to the ingredients shown in Table 1.

TABLE 1
Example coating composition

| Ingredient | Amount (wt. %) |
|---|---|
| Polyvinyl alcohol, MW ≈ 200,000, | 4.2 |
| 88 mol % hydrolysis | |
| Boric acid | 0.3 |
| Isopropyl alcohol | 2.3 |
| Phosphoric acid, 85% | 6.3 |
| 1,5-Pentanediol | 8.0 |
| Water | balance |

Print media coated with the composition shown in Table 1 showed excellent control of intercolor bleed and coalescence when subsequently printed on using aqueous pigment-based inkjet inks. Furthermore, the presence of phosphoric acid suppresses corrosion of stainless steel making the composition highly suitable for coating print media using a flexo printing process.

It will, of course, be appreciated that the present invention has been described by way of example only and that modifications of detail may be made within the scope of the invention, which is defined in the accompanying claims.

1. A method of applying a coating composition to print media comprising the steps of:
coating a metal roller with the coating composition; and
transferring the coating composition to the print media to provide a coated print media,
wherein the coating composition is an acidic aqueous-based composition comprising:
(i) a water-absorbing component selected from the group consisting of: hydrophilic polymers and hydrophilic metal oxides; and
(ii) phosphoric acid.

2. The method of claim 1, wherein the metal roller is an anilox roller of a flexo printing assembly.

3. The method of claim 1, further comprising the step of printing onto the coated print media using an inkjet printhead.

4. The method of claim 3, wherein the inkjet printhead ejects an aqueous pigment-based ink.

5. The method of claim 1, wherein the hydrophilic polymer is a polyvinyl alcohol.

6. The method of claim 1, wherein the hydrophilic metal oxide is selected from the group consisting of: fumed silica and fumed alumina.

7. The method of claim 1, wherein the coating composition further comprises a pigment-aggregating component.

8. The method of claim 7, wherein the pigment-aggregating component is selected from the group consisting of: multivalent metal salts and cationic polymers.

9. The method of claim 1, wherein the coating composition further comprises a polymeric binder.

10. The method of claim 9, wherein the polymeric binder is selected from the group consisting of: styrene-acrylic polymers and polyurethanes.

11. The method of claim 1, wherein an amount of the hydrophilic polymer is in the range of 0.1 to 10 wt. %.

12. The method of claim 1, wherein an amount of phosphoric acid is in the range of 0.05 to 10 wt. %.

13. The method of claim 1, wherein the coating composition has a pH in the range of 2 to 4.

14. An acidic aqueous-based coating composition comprising:
(i) a water-absorbing component selected from the group consisting of: hydrophilic polymers and hydrophilic metal oxides; and
(ii) phosphoric acid.

15. The acidic aqueous-based coating composition of claim 14, wherein the composition comprises a polyvinyl alcohol.

16. The acidic aqueous-based coating composition of claim 14, wherein the hydrophilic metal oxide is selected from the group consisting of: fumed silica and fumed alumina.

17. The acidic aqueous-based coating composition of claim 14, wherein the coating composition further comprises a pigment-aggregating component selected from the group consisting of: multivalent metal salts and cationic polymers.

18. The acidic aqueous-based coating composition of claim 14, further comprising a polymeric binder selected from the group consisting of: styrene-acrylic polymers and polyurethanes.
